(19) United States
(12) Patent Application Publication
(10) Pub. No.: US 2006/0238322 A1
(43) Pub. Date: Oct. 26, 2006

(54) Tire pressure gauge on dash

(76) Inventor: Albert F. Thomas, Donalds, SC (US)

Correspondence Address: Albert F. Thomas, 309 Smith Street Ext., Donalds, SC, 29638, US

(21) Appl. No.: 11/355,157

(22) Filed: Apr. 20, 2005

(51) Int. Cl. B60C 23/02

(52) U.S. Cl. 340/442

(57) ABSTRACT

The inventor has designed a rotating brush, and slip ring system allowing a continuous electrical connection between a rotating wheel and stationary chassis. Used with an on dash instrument, an on tire rim pressure sensor, and wiring harness, will allow a driver to monitor the tire pressure in any of the tires whether at rest or at any speed. The on rim air pressure sensor would be mounted so as the diaphragm would be in contact with the air pressure in a tire. The slip rings are to be composed of a highly conductive material so that the electrical signal would be passed on through the harness to the electrical instrument on the dash. This system is limitless and could be used on any type machine that incorporates rotating pneumatic tires.

### 1. DESCRIPTION

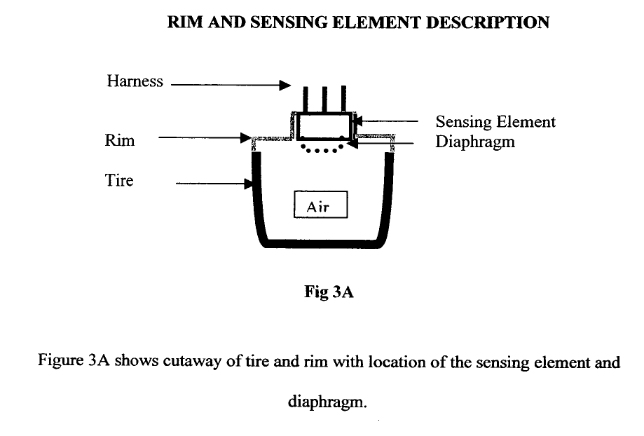

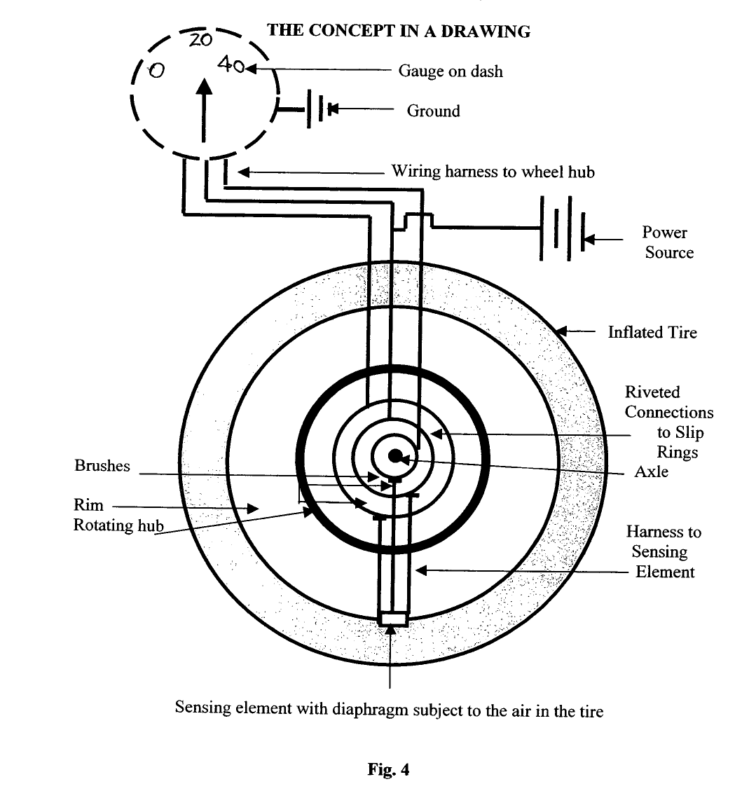

A. The inventor has designed a rotating brush, and slip ring system to allow a continuous electrical connection between a rotating wheel and stationary chassis see FIG. 4 the concept in a drawing.

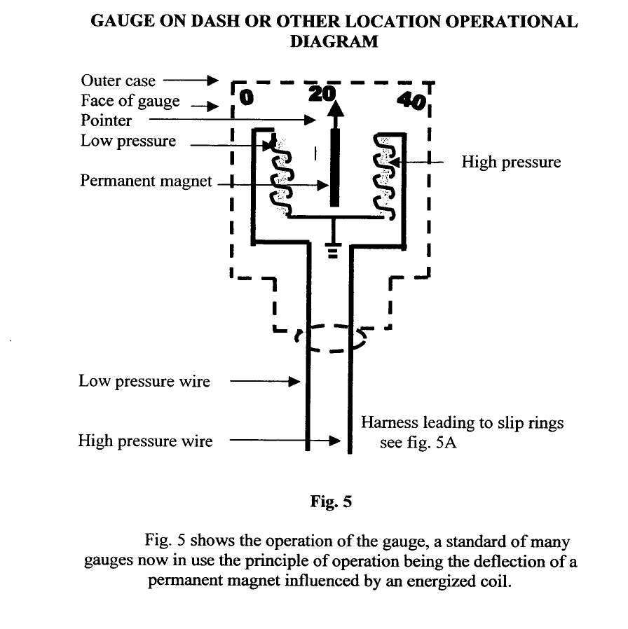

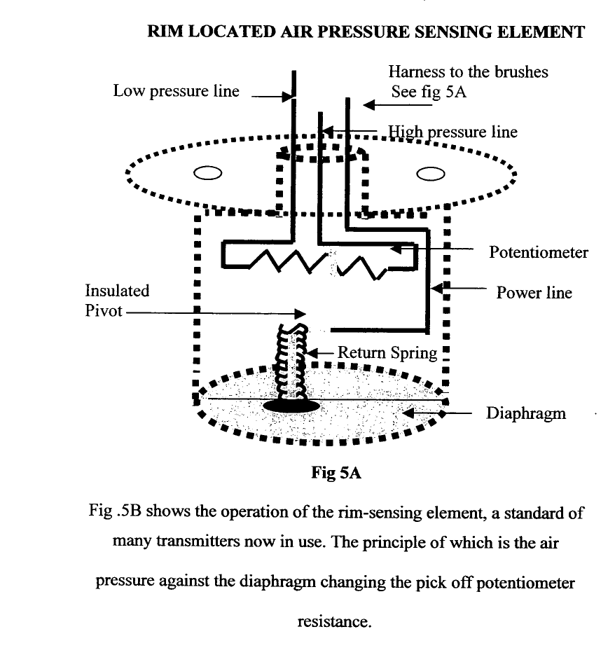

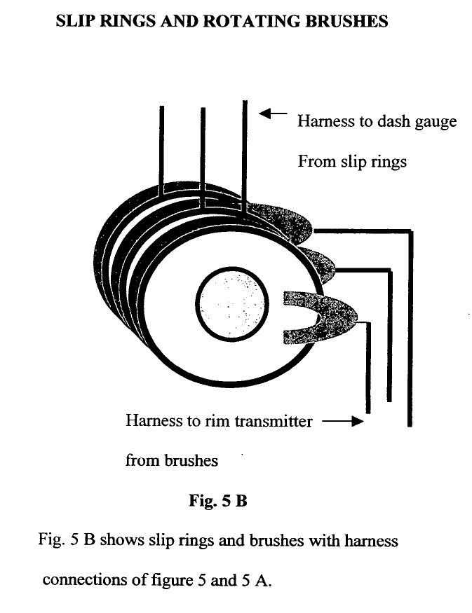

B. The use of this system along with an on dash instrument FIG. 5, and an on tire rim pressure sensor FIG. 5A using wire harness will allow a driver to monitor the tire pressure in any of the four tires or spare tire whether at rest or at any speed.

C. The dash gauge would be designed and calibrated according to the vehicle on which it may be used, and the theory of operation is as many gauges already in use see FIG. 5.

D. The on rim air pressure sensor would be mounted so as the diaphragm would be in contact with the air pressure in a tire. The theory of operation is as many sensors or pressure transmitters now in operation see FIG. 5 A.

E. The operational diagram FIG. 5 and the concept in a drawing FIG. 4 explains the operation of this system and its assembly would more or less be the ability to follow a wiring diagram.

F. The brush assembly would need to be manufactured in a technical atmosphere taking care to make the brushes with four contact points, so that the possibility of failure is decreased by seventy five percent (75%), since any one of the contacts would support full operation of the monitoring system. It is highly unlikely that all four contacts would become defective at one time.

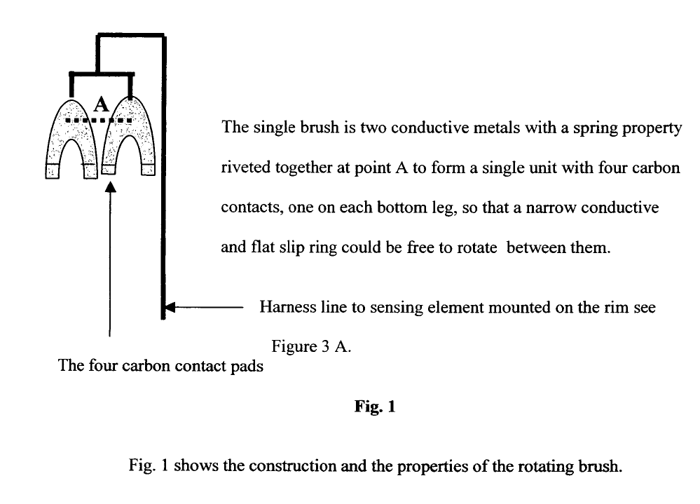

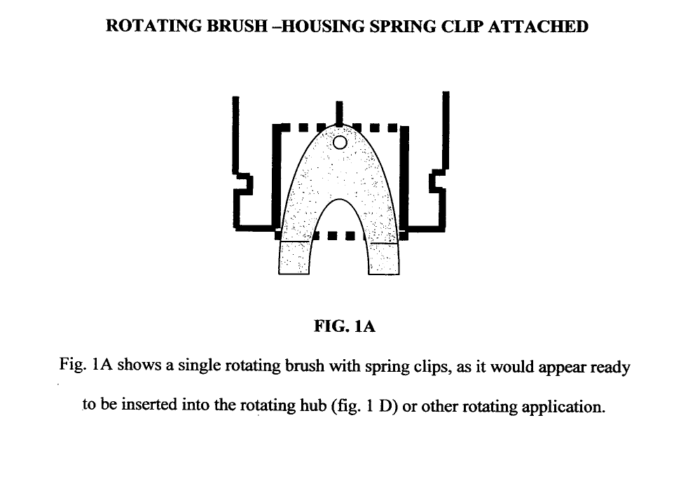

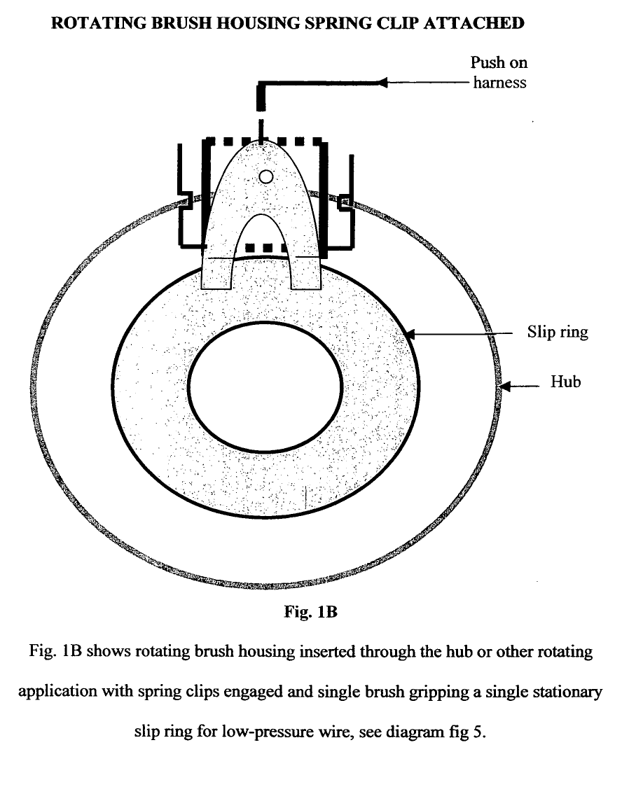

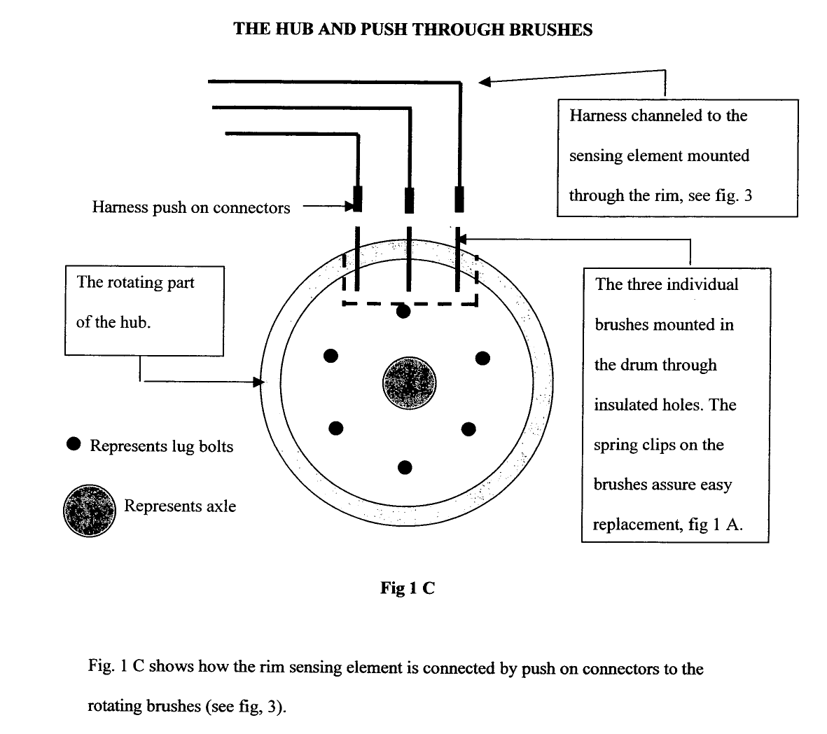

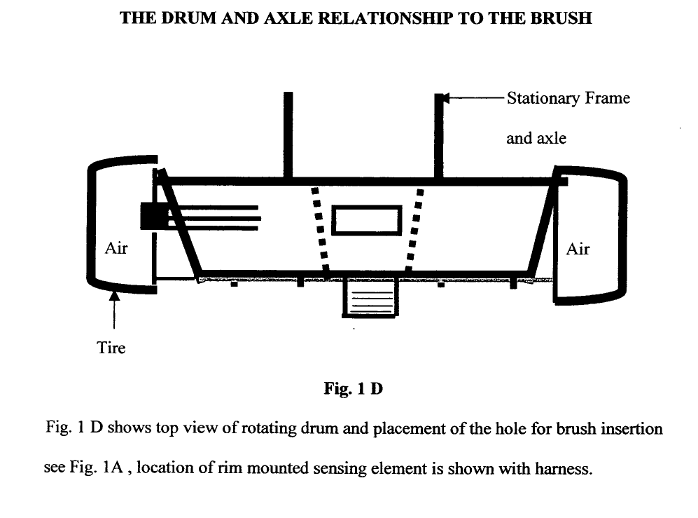

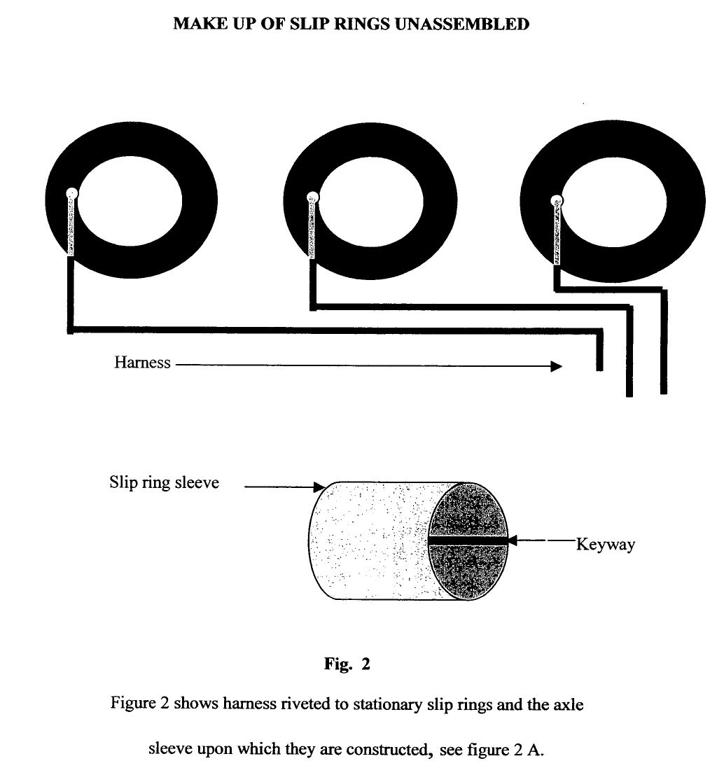

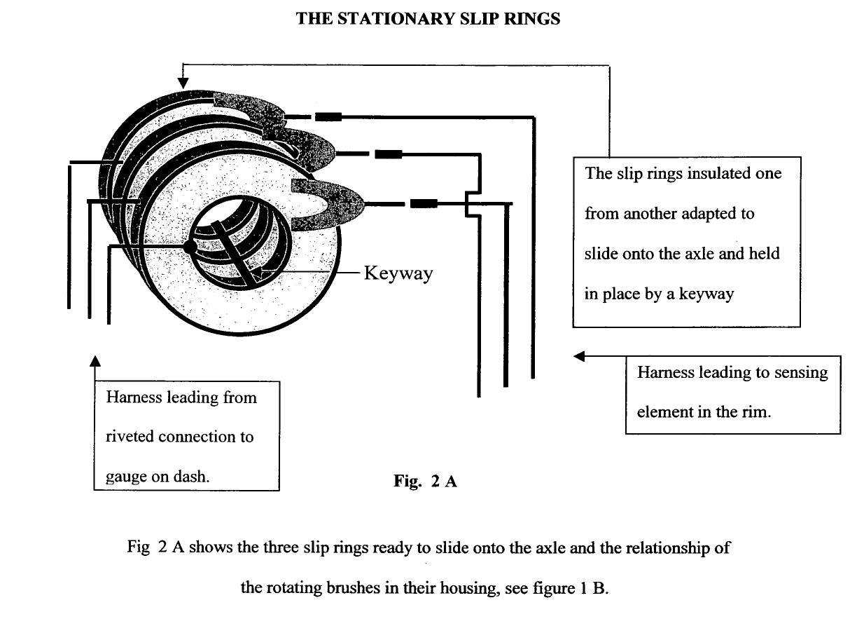

The brushes are made of spring type material so that the thin slip ring could slip between them. The nonconductive case would be a small boxlike structure that could be molded together sandwich style when the components have been placed inside. The internal components would consist of the brush as pictured in the rotating brush drawing FIG. 1. It would also include the spring clips that allow the brushes to be inserted as a unit into the prepared hole in the automobile hub, or into any applicable mounting base. The molded brush unit is constructed for easy replacement see Brush-Housing Spring Clips drawing FIG. 1 A.

The slip rings are to be composed of a highly conductive material so that the electrical signal would be passed on through the harness to the electrical instrument on the dash.

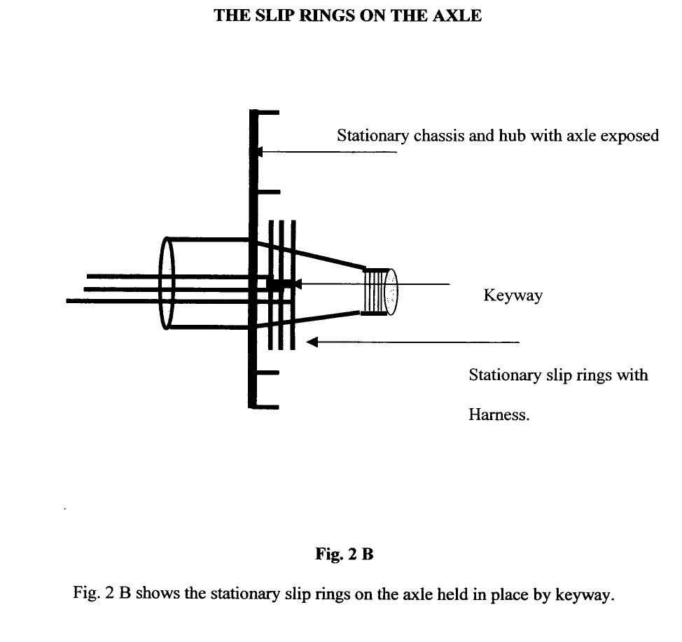

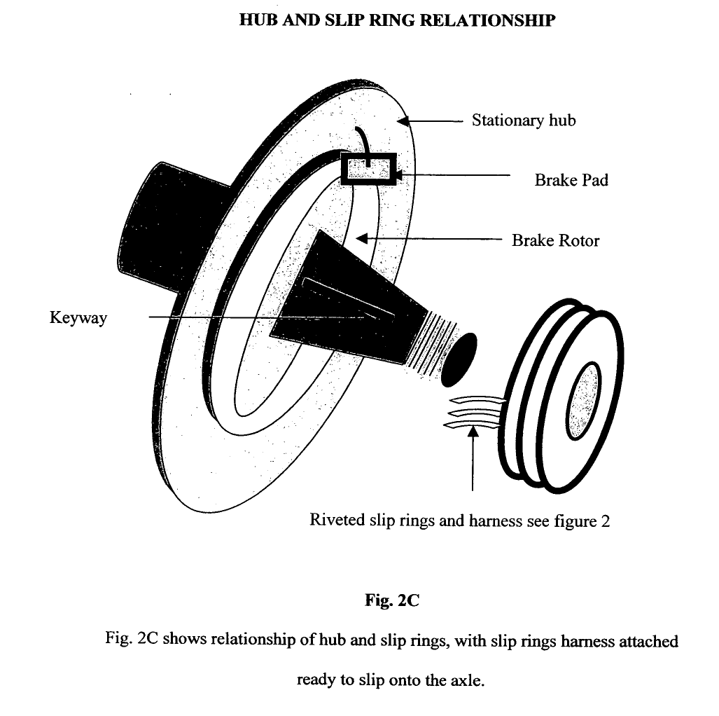

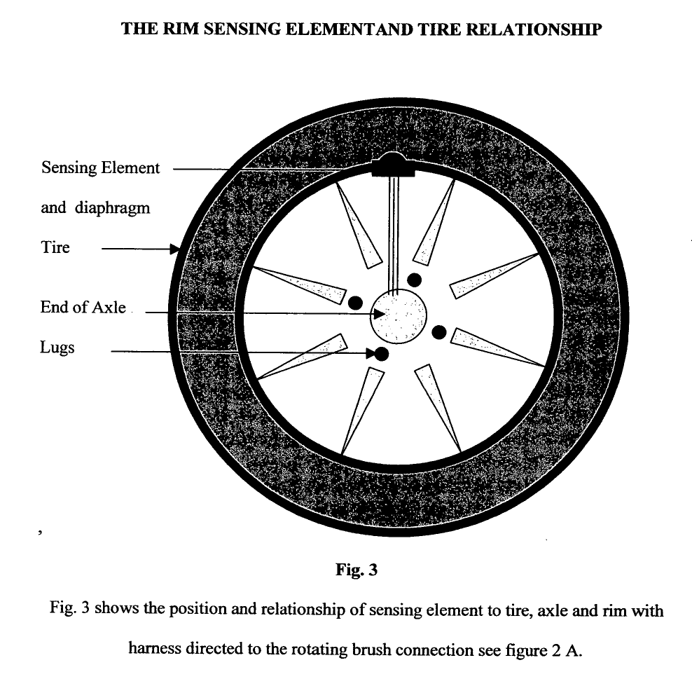

These rings would be mounted in whatever fashion needed for the particular vehicle, machine, or assembly in which it is being applied see The Slip Ring drawing FIG. 2 A.

G. This system is limitless and could be used on any type machine that incorporates rotating pneumatic tires.

H. The inventor would work with the automobile industry in carrying out the invention. The automobile industry is singled out because of the National Highway Traffic Safety Administration's having issued a mandate to all automakers that a tire pressure monitoring system must be established in the near future.

I. The inventor claims that the rotating brush around a stationary slip ring that allows a direct electrical connection between moving rotating parts and stationary parts is his design and invention.

1. Independent
A. Since there can be no direct rigid connection between a rotating wheel and a stationary chassis (or object) the inventor has designed a Rotating Brush and Slip Ring Assembly that allows a continuous electrical connection between a rotating wheel (the rim and tire) and the stationary chassis allowing the necessary components to be connected by wiring harness so that tire pressure can be monitored by a gauge on the dash, at rest or at any speed. The inventor claims that the design of the brush and the fact that it rotates around a stationary ring is his invention and desires a patent for the rotating brush and slip ring connection.
